(19) United States
(12) Patent Application Publication
(10) Pub. No.: US 2008/0086921 A1
(43) Pub. Date: Apr. 17, 2008

(54) Modular Structure Display Device

(75) Inventors: Eric Bihr, Meys (FR); Jonas Osterberg, Haute Rivoire (FR)

Correspondence Address: HESLIN ROTHENBERG FARLEY & MESITI PC, 5 COLUMBIA CIRCLE, ALBANY, NY, 12203, US

(73) Assignees: Prismaflex International, Haute Rivoire (FR); Prismaflex AB, Malmo (SE)

(21) Appl. No.: 11/908,239

(22) PCT Filed: Dec. 23, 2005
(86) PCT No.: PCT/FR05/51143

§ 371 Date: Sep. 10, 2007

(30) Foreign Application Priority Data
Mar. 30, 2005 (FR) 0550819

(51) Int. Cl. G09F 11/24

(52) U.S. Cl. 40/470

(57) ABSTRACT

A display device with horizontal or vertical, alternating or continuous scrolling of at least two juxtaposed posters forming a strip, comprises a substantially rectangular parallelepiped outer geometry with the posters being viewed on a rectangular front frame. The strip is driven in a translational movement parallel to the front frame by at least one power roller. The device further comprises two independent modules, each adapted for rotationally guiding at least one power roller or at least one idle roller. The modules are assembled together by at least one beam and are located on the shorter sides of the rectangle formed by the front frame.

### FIELD OF THE INVENTION

The invention relates to a device for displaying scrolling juxtaposed images forming a strip. Such a display device can, in particular, be used as a medium for several advertising campaigns when used as an advertising poster panel.

The invention relates more particularly to a modular structure which is relatively non-bulky in particular and easy to disassemble into several independent elements and has many advantages, especially when it comes to transporting it from the site where it is manufactured to the location where it is installed.

### DESCRIPTION OF THE PRIOR ART

Generally speaking, display devices are built from rigid, factory-assembled boxes which are then transported to their place of use.

As described in Document EP 0 214 587, this type of display device assembled in box form is very suitable for small-sized posters, especially posters having a surface area of less than 2 m². In fact, in this case the boxes can be transported easily in a standard vehicle to their place of use.

In addition and as described in Document DE 201 03 997 U1, display devices comprising a floor-standing base are also known. A top is then positioned facing this base and secured at a specific distance by means of rods. An upper power roller is guided in rotation relative to the top and a lower roller acts as a counterweight and is concealed inside the base. This roller is not guided in rotation relative to the base.

Such a display device is therefore not suitable for large posters and transporting it and assembling its various component parts is not easy to achieve. In fact, the base must be positioned level and then the independent lower roller must subsequently be fitted.

Besides this, for certain applications, especially for very large-sized display devices as described by the Applicant in Document EP 1 092 216, transporting an assembled device in box form can be extremely problematic and even impossible.

Thus, the object of the invention is to facilitate the handling and transport of display devices from the site where they are produced to the place where they are used which can be very remote and may involve transport by air in particular. To achieve this, the invention proposes to minimise the number of independent elements whilst facilitating their subsequent assembly.

Also, the strip of posters is wound around drive rollers, one of which at least is motor driven. The rollers are necessarily longer than the width of the strip of posters and this results in very significant weights, especially in the case of large-sized panels. The load-bearing mechanical structure and the bearings capable of providing a revolute joint between the various rollers and the rest of the device must therefore be dimensioned accordingly.

Another object of the invention is to use drive rollers that are as short as possible in order to reduce firstly the weight of the display device and secondly the entire mechanical structure intended to support them. Using rollers with compact dimensions makes them easier to transport and simplifies the load-bearing mechanical structure of the display device.

### DESCRIPTION OF THE INVENTION

The invention relates to a display device with horizontal or vertical, alternating or continuous scrolling. In fact, this type of display device can be used to scroll at least two juxtaposed posters forming a strip which can be endless in which case scrolling is continuous and the images scroll in a single direction. The strip can also be discontinuous. In this case, each of the ends of the strip is attached to a roller and scrolling is then alternating in two opposite directions.

Such a device comprises a substantially rectangular parallelepiped outer geometry and the posters are viewed on a rectangular front frame. The strip is driven in a translational movement parallel to the front frame by means of at least one power roller.

The term “substantially parallelepiped” also includes prismatic shapes, the base of which can, in particular, be a trapezoid. In this case, the face on the front frame can be wider than the rear face of the device. Such a layout then makes it possible to achieve an optical effect which aims to make the device look slimmer.

The device is characterised in that it comprises two independent modules, each including means for rotationally guiding at least one power roller or at least one idle roller. The modules are assembled together by at least one beam and arranged on the shorter sides of the rectangle formed by the front frame.

In other words, such a device consists of at least three elements joined together. The beam makes it possible to keep the two modules a predetermined distance apart depending on the largest dimension of the posters to be scrolled. Also, the power rollers or idle rollers are arranged with a revolute joint relative to the structure of each module. Each roller is therefore constantly protected inside the space defined by one module.

These characteristics give the device a modular structure enabling it to be easily transported and assembled on-site. Also, the modules are small and this makes them easier to handle, store and makes it possible to reduce the size of the roller associated with the motor module of the display device.

Advantageously, the display device may comprise means of transversely tensioning the strip. Such tensioning is obtained by stretching the strip at right angles to the direction in which it moves. This transverse tensioning makes it possible to give the poster visual qualities in terms of flatness regardless of the conditions of the external medium in which the poster is presented. Transverse tension makes it possible, in particular, to improve the wind resistance of the poster.

In practice, the means of transversely tensioning the strip may comprise slide rails into which the beads or equivalent on the edges of the strip fit.

In fact, the strip can be provided, at the level of its edges, with shaped portions having a bead shape and be capable of fitting into the end of a slide rail. A flat portion of the bead emerges from the slide rail at the level of a groove and is attached by means of bonding, welding or the like to the strip formed by the posters.

If the strip is of the endless type, the bead is also endless at the level of the edges of the strip. Such a bead can be made of a material with a low coefficient of friction so as to facilitate sliding of the bead inside the slide rail.

In one particular embodiment, at least one of the slide rails can be capable of transverse translational movement relative to the direction in which the strip moves. In fact, movement of this slide rail relative to the other slide rail makes it possible to adjust the tension of the strip and, in particular, at the level of the face where the posters are viewed in the front frame.

Advantageously, the means of tensioning the strip transversely comprise elastic return components attached by their ends to the moving slide rail, on the one hand, and to the beam which joins the two modules, on the other hand.

In other words, tensioning of the strip is obtained by stretching the elastic return components in an operating position. The strip is then inserted into the moving slide rail thus making it possible to obtain transverse tensioning of the strip. The elastic return components constantly tend to return to their idle position and move the slide rail closer to the beam to which they are fixed.

In practice, the display device may comprise means of longitudinally tensioning the strip. Such tensioning can be obtained, in particular, by controlling the electric power supply to the power rollers. In another embodiment, this tensioning can also be obtained by modifying the distance between the centres of two rollers, thereby reducing or increasing the distance traveled by the strip.

The means of longitudinally tensioning the strip may comprise a moving roller capable of translational movement relative to at least one power roller with a revolute joint to one of the modules.

This way it is possible to use only a single power roller and the moving roller capable of translational movement is not motor driven. This “idle” roller has both a revolute joint to allow guiding of the strip and also a prismatic joint in a direction perpendicular to its axis of rotation in order to create longitudinal tension.

In practice, the moving roller capable of translational movement which makes it possible to obtain longitudinal tension may be located inside or outside a module.

If the moving roller is located inside a module, the routing of the strip makes it easier to assemble the two modules that form the display device and fit the strip in such a device.

In another variation, the moving roller capable of translational movement can be located outside the modules between two beams.

In fact, in certain embodiments, especially if the number of juxtaposed posters exceeds two, the travel of the strip must be increased inside the parallelepiped shaped device. The strip makes a detour and its path may include back-and-forth travel between the visible face of the strip on the front frame and the rear face of the device.

The means of producing translational movement of the moving roller can be of various types, in particular they may use mechanical means such as pulleys with a counterweight in order to exploit the force of gravity in order to move the moving roller. Nevertheless, various means can be used, especially elastic return means or electrical devices in order to remotely and automatically control translational movement of the moving roller.

In practice, the display device may comprise means of fixing on its rear face. This way, the display device can be suspended by its rear face from a wall or existing panel. This fixing means may be confined only to the area of the independent modules or may extend to the beams which link the two modules.

For certain applications, particularly in outdoor environments, the device may also comprise a system to illuminate the scrolling strip. Such a system may operate on the principle of backlighting with the strip passing in front of the lighting panel so as to allow viewing of posters even when it is dark. The strip is backlit to make it constantly visible or ensure that it catches the attention of passers-by thanks to its extremely vivid colours.

Different variations can be produced, in particular each module may comprise several power rollers. The rollers can be individually motor driven by means of several motors but they can also be driven by a single motor which drives a chain or a belt that links the various power rollers.

Advantageously, the motor drive can be located in a housing that is independent of the module or at the end of the rollers. If both the modules of a single device each comprise at least one power roller, electronic means of control may make it possible to synchronise the power supply to the various rollers so as to obtain longitudinal tensioning of the strip as well as alternating scrolling movement of the strip.

### BRIEF DESCRIPTION OF THE DRAWINGS

In order that the way in which the invention is implemented and its resulting advantages may more readily be understood, the following embodiment is described, merely by way of example, reference being made to the accompanying drawings:

FIGS. 1 and 2 are perspective views of a device, in its assembled and disassembled configuration, in accordance with the invention.

FIGS. 3 and 4 are top views of two variations of a device such as that shown in FIG. 1.

FIG. 5 is a side view of the device in FIG. 1 mounted on a wall.

FIG. 6 is a partial cross-sectional view of the variation in FIG. 4.

FIG. 7 is a partial perspective view of a means of transversely tensioning the strip in accordance with the invention.

FIG. 8 is a front view of the display device in accordance with the invention.

FIG. 9 is a cross-sectional view of the display device in FIG. 8.

### DESCRIPTION OF THE PREFERRED EMBODIMENTS

As stated earlier, the invention relates to a device for displaying a strip comprising at least two juxtaposed posters forming a strip.

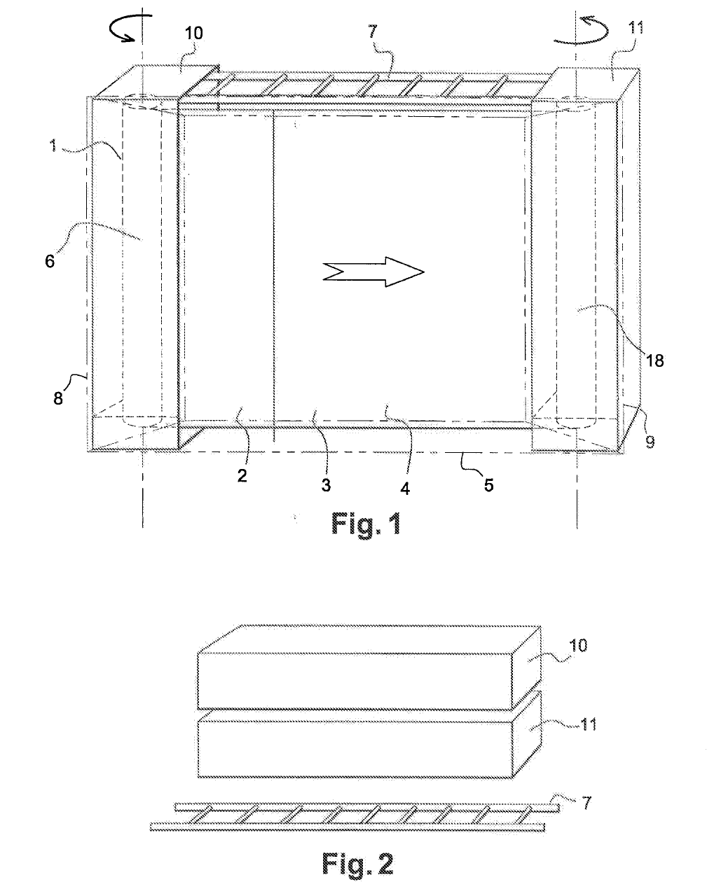

As shown in FIG. 1, the posters can scroll horizontally and continuously in a single direction. Such a device (1) thus comprises two independent modules (10, 11) attached to each other by means of a beam (7).

A strip (4) of at least two posters (2, 3) is then translationally moved parallel to front frame (5) so as to allow display of the various posters (2, 3).

According to the invention, at least one of modules (10) comprises a power roller (6) in order to drive strip (4) translationally and means of guidance making it possible to obtain a revolute type joint between power roller (6) on the one hand and the structure of module (10) on the other hand.

Also, the other module (11) comprises an idle roller (18) which is not rotationally driven. However, such a module (11) also comprises means of guidance making it possible to obtain a revolute type joint between idle roller (18) on the one hand and the structure of module (11) on the other hand.

Modules (10, 11) are arranged on the shorter sides (8, 9) of the rectangle formed by front frame (5).

Thus, as shown in FIG. 2, such a display device can be disassembled into at least three non-bulky elements. Device (1) comprises two modules (10, 11) which can be stacked one on top of each other and beam (7) designed to maintain a constant distance between the two modules (10, 11). Such a device is thus very simple to transport and not at all bulky to store.

When such a large-sized display device needs to be transported, it can be disassembled and packed before shipment to its place of use. This way, it is possible to use conventional means of transport such as industrial type lorries if the place of use is relatively close or air transport if it is far away.

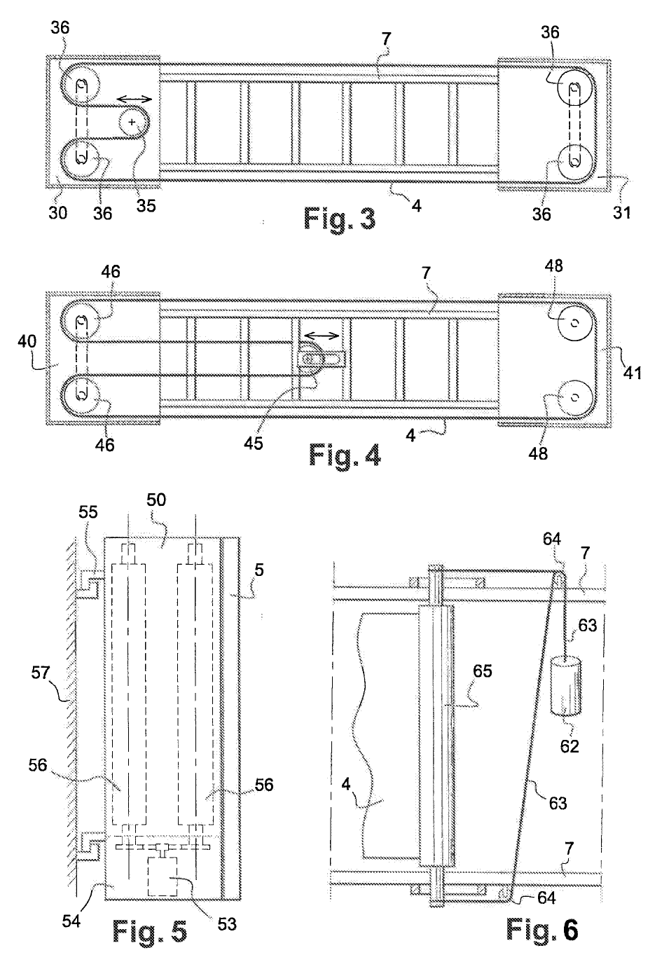

As shown in FIG. 3, such a device may comprise a plurality of power rollers (36). In this variation, two modules (30, 31) are equipped with power rollers (36), driving of which is synchronised by means of one or more chains or belts on each module (30, 31). Advantageously, the power supply can be synchronised between the two motor-driven assemblies of each of the modules.

As shown, one roller (35) can be arranged on one module (30) so as to obtain longitudinal tensioning of strip (4).

As shown in the variation in FIG. 4, one roller (45) positioned against the two modules (40, 41) can also be used to obtain adjustment of the longitudinal tension of strip (4). This configuration is especially suitable in cases where the number of posters forming the strip exceeds two.

In this variation, module (40) comprises two power rollers (46) which are synchronised by means of a chain. Module (41) comprises two idle rollers (48) which are not rotationally driven by means of a motor but are simply guided in rotation by means of guidance elements so as to obtain a revolute joint between module (41) and the two idle rollers (48).

As shown in FIG. 5, the display device can be fixed by its rear face to a wall (57) such as an existing wall or poster panel structure. Lengths of L-section profile (55) can be used to fix the device very simply by having these profiles cooperate with lengths of matching or identical profiles attached to wall (57).

As shown, module (50) may consist of a lower motor drive part (54) equipped with a motor (53). This motor (53) can be used to drive several power rollers (56) by means of a chain or a synchronous belt in particular.

A front frame (5) is mounted on the front face in order to conceal components of the display device which are visually unattractive.

As shown in FIG. 6, roller (65) capable of producing longitudinal tension in strip (4) can be attached by its ends to tension ropes (63). These ropes (63) converge together, thanks to a system of pulleys (64), on a suspended mass (62). The force of gravity then makes it possible to constantly tension strip (4) in a direction parallel to the direction in which it moves.

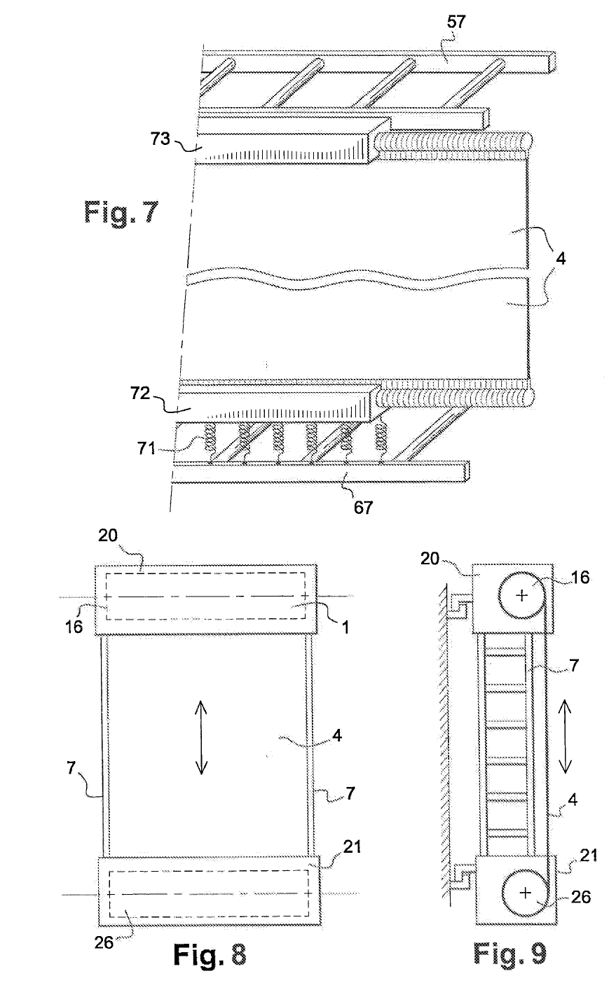

As shown in FIG. 7, transverse tensioning of strip (4) can be obtained by inserting the edges equipped with beads inside slide rails (72, 73). In the variation shown, slide rail (73) is fixed relative to beam (57) whereas slide rail (72) is mobile relative to beam (67). Elastic return components such as springs (71) can be used to produce the desired transverse tension by constantly pulling the two slide rails apart.

As shown in FIG. 8, device (1) may also be designed to produce vertical scrolling of strip (4). In addition, movement of strip (4) can be alternating in opposite directions and, in this case, be driven by means of two power rollers (16, 26) located in the two modules (20, 21). Each of the two modules (20, 21) thus comprises a motor capable of driving a roller in two directions. The power supply of the various motors must then be synchronised in order to make it possible to obtain longitudinal tensioning of strip (4). This example of an embodiment of display device (1) comprises two beams (7) located either side of strip (4).

As shown in FIG. 9, the display device may, in the case of an alternating scrolling system, only comprise two rollers (16, 26) which must then necessarily be motor driven. In addition, in the case of a device with vertical scrolling of strip (4), the device can be fixed by its rear face by means of lengths of profiles that extend along modules (20, 21).

The above descriptions demonstrate that a display device in accordance with the invention offers numerous advantages, in particular:
it facilitates the transport and storage of very large-sized display devices
it makes it possible to reduce the weight of the rollers and therefore simplify the mechanical structure for retaining the rollers inside the device;
it can be assembled on-site very quickly and is simple to maintain because, in particular, it is possible to change just one module.

1. A display device with horizontal or vertical, alternating or continuous scrolling of at least two juxtaposed posters forming a strip, said device comprising a substantially rectangular parallelepiped outer geometry, the posters being viewed on a rectangular front frame, said strip being driven in a translational movement parallel to said front frame by at least one power roller, and further comprising two independent modules each comprising means for rotationally guiding the at least one power roller or at least one idle roller, said modules being assembled together by at least one beam and being located on shorter sides of a rectangle formed by the front frame.

2. A display device as claimed in claim 1, further comprising means of obtaining transverse tensioning of the strip.

3. A display device as claimed in claim 2, wherein the means of obtaining transverse tensioning of the strip comprise slide rails into which the beads on the edges of the strip penetrate.

4. A display device as claimed in claim 3, wherein at least one side rail moves translationally and transversely relative to a direction in which strip moves.

5. A display device as claimed in claim 4, wherein the means of obtaining transverse tensioning of the strip comprise elastic return components at one end to a moving slide rail, and, at another end, to the beam which joins the two modules.

6. A display device as claimed in claim 1, further comprising means of obtaining longitudinal tensioning of the strip.

7. A display device as claimed in claim 6, wherein the means of obtaining longitudinally tensioning of the strip comprise a moving roller adapted for translational movement relative to at least one power roller with a revolute joint to one of the modules.

8. A display device as claimed in claim 7, wherein the roller adapted for translational movement is located inside a module.

9. A display device as claimed in claim 7, wherein the roller adapted for translational movement is located outside the modules between two beams.

10. A display device as claimed in claim 1, further comprising means for mounting on a rear face.

11. A display device as claimed in claim 1, further comprising a system for illuminating the strip.
